(19) United States
(12) Patent Application Publication
(10) Pub. No.: US 2016/0194467 A1
(43) Pub. Date: Jul. 7, 2016

(54) PROCESS FOR THE MAKING OF COMPOSITE MATERIAL PRODUCTS HAVING REINFORCING LAYERS AND RESIN

(71) Applicants: COMPNEXT S.R.L., Frosinone (IT); DLC CAPITAL HOLDINGS PTY LTD, Carlton South, Victoria (AU)

(72) Inventors: Donato Colantonio, Frosinone (IT); Fabrizio Procaccini, Frosinone (IT)

(73) Assignees: Compnext S.R.L., Frosinone (IT); DLC Capital Holdings Pty Ltd, Carlton South, Victoria (AU)

(21) Appl. No.: 14/908,983

(22) PCT Filed: Aug. 1, 2014
(86) PCT No.: PCT/IB2014/001439

§ 371 Date: Jan. 29, 2016

(30) Foreign Application Priority Data
Aug. 1, 2013 (IT) RM2013A000451

(51) Int. Cl. C08J 5/24; C08J 5/04; D06M 11/68; D06M 13/256; B29C 70/48; B29B 15/08

(52) U.S. Cl. CPC C08J 5/24; B29C 70/48; B29B 15/08; D06M 11/68; D06M 13/256; C08J 5/042; B29K 2105/0014

(57) ABSTRACT

There is provided a process for the making of composite material products, said products comprising a layered structure comprising at least one reinforcement layer made of fibers or fibrous fabric, and at least one layer of resin that impregnates said at least one reinforcement “fibrous layer within a mold, the process is characterized in that it comprises the following steps: Pretreatment of said reinforcement fibers or fabric through pre-impregnation with only a catalyst compatible with said resin; —Pretreatment of said resin by diluting with a compatible diluent until a predetermined viscosity; Addition of a catalyst to the pretreated resin; Arrangement of said pre-preg reinforcement fibers or fabric with only the catalyst inside of said mold; and —Impregnation of said pre-preg reinforcement fibers- or fabric through said resin within in said mold. It is also provided a product obtained by the present process.

### FIELD OF THE INVENTION

The present invention relates to a process for the making of composite material products having reinforcement material and resin. More precisely, the invention relates to a process for the making of composite material products such as laminated products and sandwiched panels that include a reinforcement material which has been pre-impregnated or admixed with a specific catalyst for the resin to which it is associated.

The invention also relates to products made of composite materials obtained through the above process.

### PRIOR ART

Today, it is widely known the use of artifacts made of composite material, mainly consisting of laminated products and sandwiched panels wherein skins or layers consist of reinforcing fibers which are subsequently impregnated with resin. The features of such products may vary according to the requirements of mechanical strength as well as resistance and reaction to fire, depending from regulations, and according to performance/lightness optimal ratios.

Typical application fields for these artifacts can be the construction, transport, aerospace, and marine industry fields.

To the above purpose, there are provided different types of resins responsible for the uses above described. These different types of resins can be listed as follows:

1) Epoxy

2) Polyesters,

3) Vinyl ester

4) Phenolic

5) Furan based

Currently, composite material artifacts for the above applications and according to the regulations in terms of mechanical strength, reaction and resistance to fire, typically use resins of the above listed types 1, 2, 3, and 4.

Such resin types 1, 2, 3, and 4 are applied through different impregnation processes onto relevant reinforcing fibers (such as, for example, glass fibers, carbon fibers, and related reinforcing materials).

For example, WO2012/102202 describes a composition of epoxy resin for resin transfer molding of a composite material that comprises one or more dry fibrous reinforcement, which are subsequently impregnated with polyfunctional epoxy resin, an alicyclic epoxy resin, a acid anhydrous curing agent, and a vulcanization accelerator.

According to this document, this composition provides superior workability to the resin during the preparation of the same resin, preserves low viscosity and has an higher impregnation when it is injected into a reinforcing fiber.

Furthermore, with reference to the use of furan based resins (above listed as type 5) document WO 00/07804 describes a resin transfer molding process, wherein the resin matrix is a furan resin which has been cured with Lewis acid catalyst.

According to this document, it is provided the use of furan based resins such as matrix resins in the resin molding processes. Moreover, with the appropriate choice of the tyke of catalyst is possible to obtain a resin system which shows low viscosity at moderate temperature and which cures at higher temperatures. The process it is addressed to dry reinforcing fibers which are subsequently impregnated with said resin.

On the other hand, it is also known that in specific applications where structural requirements and weight are very straight, pre-impregnated reinforcing materials can be used, and where a catalyzed and pre-polymerized resin is used, and these pre-impregnated materials are so-called “pre-preg” fabric. However, these “pre-preg” fabrics must be kept stored at temperatures below zero before the use thereof.

For the use of such types of “pre-preg” fabrics it is provided that the sheets of fabric are first positioned into a mold in a different layers arrangement, and depending on the desired strength of the article. Then the whole (i.e., the entire mold and the sheets) is put under vacuum. Subsequently, the manufactured article inside the mold it is polymerized by means of pressure and temperature control within an autoclave. At the exit of the autoclave, there is obtained a polymerized artifact in a “ready to be used” condition to which it is addressed.

An example of this type of technology it is described in EP1408152A1, where there is provided a reinforcing material which comprises a substrate of carbon fibers having good handling properties. In particular, the object of the invention it is to provide a substrate of pre-preg reinforcing carbon fibers with a first type of resin, and such that during the assembly within preforms the same it is impregnated with other types of resin, obtaining excellent handling properties, stability shape, and adhesiveness.

The management and production costs of such a solution are very expensive and limited to high technological sectors.

On the other hand, and in the specific case of lamination for the production of products having high fire resistance in compliance with the standards requirements, possible solutions are as follows:

a) Basic format resins (i.e., not pre-preg) with addition of fire inhibitors. The use of fire inhibitors greatly increases the viscosity of the resins from 500 to 2000 cps. Thus, they must be applied with manual skills. The use of such high viscosity resins reduces the amount of the reinforcing fiber per volume unit in the final article, and by degrading accordingly the mechanical features of the latter and preventing the use thereof for structural purposes; alternatively

b) Pre-preg fabrics with fire retardant resins.

Furthermore, the resins of types 1, 2, 3, and 4 show problems in terms of storage and handling thereof. The storage of such resins, due to their high flammability, must be carried out in isolated places or in separate places where they are produced, by means of fire-resistant structures and communication ways equipped with fire resistant doors.

The handling and the moving of such resins must be supported by a dedicated program of staff training on safety measures to be observed, and the knowledge of the properties, of substances and circumstances that may increase the risk of fire, with the increase in operating costs for the companies.

In addition to the above-described disadvantages upon using resins with added “inhibitors”, further disadvantages are foreseen for such resins and as listed here below:

a) Repeatability of the weight of the artifacts it is not guaranteed;

b) Delamination problems in the layers of the artifacts can be shown, due to the presence of metal fillers used as additives;

c) They are classified as “flammable” and “harmful”;

d) They need to be kept in a cool, well-ventilated place, keep away from heat, flames, sparks and other sources of ignition.

e) Inhibitor use brings to an excessive consumption of resin;

f) They are applicable only through the process of manual impregnation;

g) They create problems for waste disposal.

On the other hand, it is known that instead the furan based resins currently available on the market, they are suitable to overcome the limits of flammability, viscosity and storage compared to conventional resins. Nevertheless, these types of resins have a high energy cost required for the production. In fact, the high water content in their composition, does not favor the complete evaporation of the same within the different layers of the fabric during the molding step. With the aim of trying to improve this aspect, there have been proposed to date different solutions, which only partially solve the above drawbacks, and which are listed here below:

a) Use of higher polymerization temperatures (above 100° C.) and longer polymerization times (greater than 5 hours). This solution makes no economic production of manufactured items.

b) Heating the mold by means of heated plates, which provide heat to both sides of the laminate allowing the evaporation of the water contained in the resin. However, this solution has limitations given by shapes (only laminated flat products can be handled).

c) The method it is not applicable for the making of sandwiched structures as the pressure applied by the plates would lead to breaking of the core of the sandwiched item; and

d) Lower temperatures but with the increase of the catalysis of the system. This solution makes the system very responsive and entails reduced time for the use of the resin.

### BRIEF DESCRIPTION OF THE INVENTION

The aim of the present invention is to solve the above-highlighted drawbacks by providing a process for the production of composite material articles having both a laminar structure or, alternatively, a sandwiched structure, and wherein said articles are manufactured by using reinforcing fiber pre-impregnated with only the specific catalyst depending upon the type of resin to which it is directed.

Another object of this invention is to provide a article made of composite material having a laminar structure or, alternatively, a sandwiched structure, and made of resin and fibers that are pre-impregnated only with the specific catalyst for the type of resin to be used.

Further object of the present invention is to provide an article made of composite material having a laminar structure or, alternatively, a sandwiched structure, which is made with furan based resin and with reinforcing material consisting of fibers pre-impregnated with only catalyst for furan-based resin, and that overcome the limits of other resins of the type 1, 2, 3, and 4.

Thus, the present invention provides a process for the production of manufactured composite material having a laminar structure or a sandwiched structure, and the articles thus realized, substantially according to the appended claims.

According to a first advantageous aspect of the present invention, the invention solves the related problems of applicability and use thereof with respect to the current existing resins charged with metallic additives, as the present modified resin according to the present invention, it shows a very low viscosity.

According to a second advantageous aspect of the present invention, with the resin of the present invention in addition to the manual impregnation process it is also possible to perform infusion and injection processes, therefore improving the features of the article, and resulting in lower consumption of resin, and the elimination of delamination problem as per the resins currently on the market.

According to a third advantageous aspect of the present invention, by impregnating the dry reinforcing fibers with only the specific catalyst according to the resin to be used, it is reduced equivalently the amount of catalyst to be added to the resin for its complete polymerization, obtaining thereby a lengthening of the use time for the resin before it has completely hardened.

According to a fourth advantageous aspect of the present invention, thanks to the fact that the reinforcement material is pre-impregnated with only the specific catalyst according to the type of resin to which it is directed, the next phase of polymerization of said resin may take place at lower temperatures with respect to those of the state of the art, thereby obtaining reduced time and reduced costs.

According to a fifth advantageous aspect of the present invention, thanks to the fact that the reinforcement material is pre-impregnated with only the specific catalyst according to the type of resin to which it is directed, curing time for the resin are reduced enormously and during the subsequent impregnation and cure in the mold steps, which involves high savings in terms of costs for the necessary heating of the process.

### DETAILED DESCRIPTION OF THE INVENTION

A detailed description of a preferred embodiment of the process for the production of composite material articles, and the article thus obtained according to the present invention will now be given, by way of non limiting example, and with reference to the appended drawings, wherein:

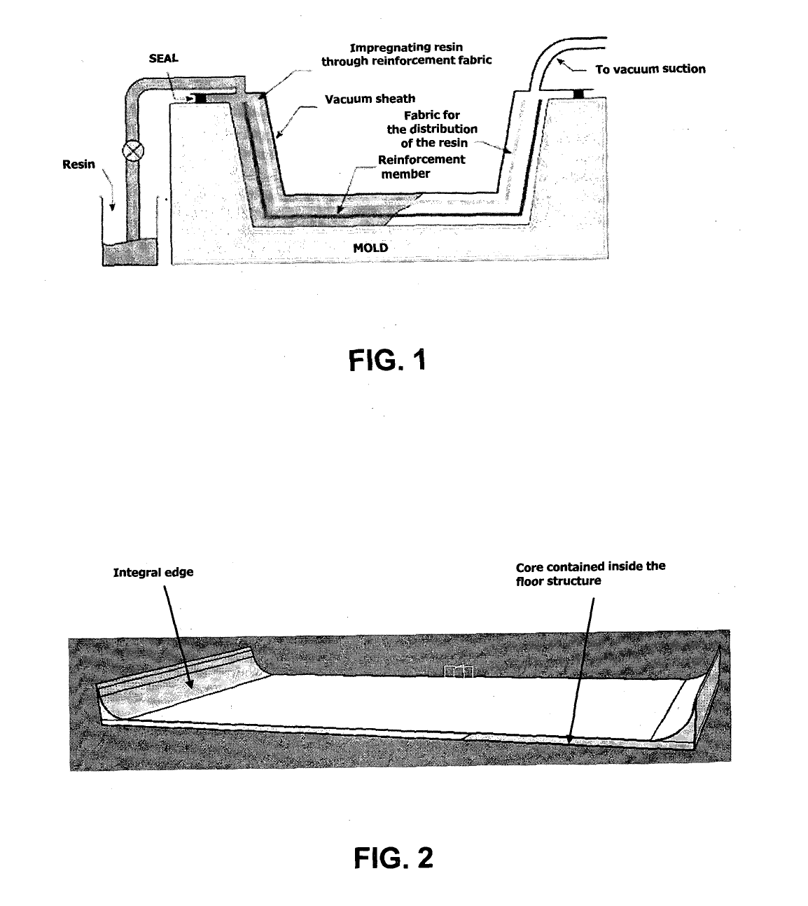

FIG. 1 is a schematic view of a mold of an apparatus for performing the method of production of composite material articles by an infusion process according to the present invention; and

FIG. 2 is a partial sectional and perspective view that illustrates a sandwiched panel made of a composite material made according to the method of the present invention.

It should here be specified that although in the present embodiment below described reference will be made to a process for the production of a composite material article wherein the resin is a furan based resin and its fibrous reinforcement material, the present invention it is not limited to this embodiment but it is also applicable to other types of non furan based resins such as, for example, epoxy resins, polyesters, vinyl ester, and phenolic resins, and wherein different catalysts are provided for each specific type of resin listed above.

According to the present embodiment, the “pre-preg” fabric is able to soak subsequent to its placement within the mold with the catalyzed resin, the latter being injected into the mold and being “sucked” within the same by means of a vacuum pump.

With reference now to FIG. 1, therein is illustrated in a schematic manner an apparatus for the making of an article having a layered structure and by means of “infusion” of the resin in a mold, and wherein there are provided several layers of reinforcement fabric, the latter being “pre-preg” according to the present invention.

According to the present embodiment, the article has a structure that is substantially constituted by three components:

a) a resin to be pre-treated and to be catalyzed;

b) a reinforcement fabric pre-impregnated only with the same catalyst of the resin; and

c) a catalyst.

In, particular, it will be provided now a non-limiting example of a composite material manufactured article wherein the resin is a furan based resin and the reinforcing material is a “pre-preg” fibrous fabric, according to the process of the present invention.

a) Pre-Treated Resin

According to the process of the present invention and with the aim to obtain a correct polymerization, the resin and the catalyst must be used in specific amounts.

So, in order to have an optimal infusion of the resin within the mold, first the resin is appropriately pretreated by diluting the same with a diluent and in order to obtain a very low viscosity thereof. More precisely, in the case of furan-based resin, the resin is pretreated by diluting it with water in percentages ranging from 10% to 15% by weight with respect to the total weight of the final mixture water-resin. The percentage of dilution with water is chosen until the required viscosity for the process ranges between 250 cps and 600 cps.

It will be apparent to those skilled in the art that in case of use of different resins from the furan based resins, the pre-treating diluent will be the diluent for the specific type of resin, and the same will be added to the resin until obtaining a predetermined final viscosity according to the process to be carried out, and according to the present invention.

Advantageously, in the case of using a furan based resin the so obtained resulting pretreated resin with water can be considered a more environmentally friendly product, a non-flammable product and non-hazardous during its use.

Furthermore, it is provided that the so diluted resin is pre-activated by the addition of a low amount of catalyst, preferably between 2% and 5% by weight with respect to the total weight of the resin and, more preferably, in the range of half (50%) of the nominal quantity of catalyst to be added to the resin expected to have a proper polymerization of the same.

b) Pre-Impregnated Reinforcing Fabric

According to the present invention, the fibrous fabric of the present invention is pre-treated in such a way as to promote the polymerization of the resin at the set temperature and with reduced times.

According to the present invention, the fibrous fabric is pre-impregnated with the catalyst only, and with an amount of catalyst defined according to the curing speed required by the process or according to the type of resin to be used. More precisely, the fabric is pre-impregnated by the addition of an amount of catalyst comprised in the interval comprised between 1% and 50% by weight with respect to the areal weight of the fabric.

Obviously, depending on the type of resin to be used, the type of catalyst will change accordingly.

Further, the treating of the fabric takes place by impregnation of a catalyst in any physical state of the same, and as long as it is compatible with the resin.

c) The Catalyst

The catalyst is of course chosen according to the type of resin and according to the technical data sheet of the manufacturer. In the example here described, reference is made to furan based resin, and therefore an acidic catalyst is chosen both for the impregnation of the fibers of the reinforcement fabric and for the pre-treating of the resin, and before arranging the whole within the mold. It can be used as catalysts all strong acids according to Brønsted, such as phosphoric acid and/or para-toluenesulfonic acid.

This catalyst guarantees a perfect polymerization reaction, and a restrained emission of fumes and/or toxic substances as a reaction to the flame.

Following to the low resin catalysis and to the pre-impregnation of fibrous fabric with the catalyst, the present applicant has found that were overcome the main limitations related to current production processes, and with particular reference to the long times and high temperatures for curing. More precisely, and according to the process of the present invention, the pre-treatment of the fabric through only catalyst gives the advantage that during the infusion and advancement steps of the low catalyzed resin trough the fabric within the mold, the resin obtains the right amount of catalyst to react exothermically, and by doing so to evaporate the right amount of water contained within in the resin.

In fact, according to the production processes of the state of the art which do not use the method of the present invention, in order to achieve the same results it would take many hours within the oven at high temperatures. For example, in an infusion process of the state of the art where it is provided the use of a mold as shown in FIG. 1, and where the workpiece represented had been carried out for infusion using reinforcing fibers which have been not pre-treated according to the process of the present invention, and wherein the heating in an oven at temperatures of 70° C. for a few hours had been carried out, in such conditions the resulting surface in contact with the mold would show a low quality appearance due to portions of the resin not perfectly polymerized. The cause of such a defect is related to the difficulty of evaporating the water through the outer layers which have a higher degree of polymerization.

According to the invention, the use of a specific quantity of catalyst impregnating the fabric, ensures an exothermic reaction for the entire surface of the impregnated reinforcement fabric, and with a total evaporation of the water contained in the resin and a complete polymerization of the article.

Advantageously, an excellent surface appearance with very short processing times is obtained.

Therefore, according to the present invention it is possible to make both laminated products including layers of fibrous reinforcement material (such as glass fibers, or carbon fibers, or similar), the layers being “pre-preg” with only the catalyst and subsequently being impregnated with the resin within the mold, and sandwiched panels (i.e., structures made up of reinforcing fibers pre-impregnated by only catalyst, a “core” made of any material, shape, and thickness, and the impregnating resin) having different types of shapes.

Furthermore, in the case of use of a furan based resin, the article will show high features of reaction to fire as well as absence of toxic fumes, due to the use of this type of resin.

For example and with particular reference to FIG. 2, according to the process of the present invention it is possible to make laminated articles that may become an innovative “composite floor” with high mechanical features, with excellent reaction to fire, and a low emissions of opaque and toxic fumes.

Indeed, panels that currently constitute the structure for floors in railway, nautical, and aeronautical sectors are made of different types of “Core”, and as “Skins” using sheets of different metal materials. The panels thus obtained, because of the coiling processes of the metallic sheet, they are limited by the width of the “coils” to a no larger than 1500 mm width. So, it is not possible the realization of a monolithic floor of width greater than 1500 mm. This implies that during the construction and the use of such state of the art panels, they must be joined together by means of adhesives or bolted joints, and in order to achieve greater widths. In addition, it is also provided the “grouting” and the “sealing” of the areas of the joints.

Advantageously, through the process of the present invention it is possible to produce structural articles such as, for example, monolithic panels considerably larger. For example, through the use of a furan based resin together with reinforcing fibers pre-impregnated with only the catalyst according to the present process, it is possible to realize floor panels with high flame resistance, and which exhibit any size, and where necessary integrating the edges to the floor panel for the containment of the washing waters and of any infiltrations of liquid at the ends thereof and along its length.

The possibility to make completely closed floors also at the edges thereof, allows to obtain floors with high mechanical features with the advantage of the easy mounting of the floor itself. For example, the possibility of making a single sandwiched panel to be used as a large floor in a monolithic structure, makes it much faster the assembly thereof by ensuring flatness tolerances with respect to a fitting of a series of panels according to the state of the art.

Thanks to the process of the present invention, it is possible to obtain products with high amount of structural reinforcement also using the furan based resin, in virtue of the very low viscosity of the latter, and without the need of adding metallic fire inhibitors which prejudice the working of the same.

The reaction to fire features (flammability and absence of toxic and opaque fumes) of the so obtained articles, it makes the same suitable to be used also in all environments with a fire risk and where fire protection is needed. For example, in the construction of elevators, and for the implementation of aesthetic items for the construction, flooring, interior and exterior parts for rail vehicles, parts construction, and flooring for the aviation industry, internal compartments and fittings for the nautical motor industry.

1. A process for the making of composite material products, said products comprising a layered structure comprising at least one reinforcement layer made of fibers or fibrous fabric, and at least one layer of resin that impregnates said at least one reinforcement fibrous layer within a mold, characterized in that it comprises the following steps:
pretreatment of said reinforcement fibers or fabric through pre-impregnation with only a catalyst compatible with said resin;
pretreatment of said resin by diluting with a compatible diluent until a predetermined viscosity;
addition of a catalyst to the pretreated resin; —Arrangement of said pre-preg reinforcement fibers or fabric with only the catalyst inside of said mold; and
impregnation of said pre-preg reinforcement fibers or fabric through said resin within in said mold.

2. The process according to claim 1, wherein said step of adding catalyst to the pretreated resin provides the adding of a catalyst amount comprised between 2% and 5% by weight with respect to the total weight of the resin.

3. The process according to claim 1, wherein said step of adding catalyst to the pretreated resin provides a catalyst amount comprised in the range of 50% of the nominal quantity of catalyst provided to have a proper polymerization of the resin.

4. The process according to claim 1, wherein said step of pre-treatment of reinforcement fibers or fibrous fabric by pre-impregnation with catalyst only comprises the addition of a quantity of catalyst comprised between 1% and 50% by weight with respect to the areal weight of the fibers or fabric.

5. The process according to claim 1, wherein said resin is chosen among the following group of resins:
Epoxy, Polyesters, Vinylester, Phenolic and Furan Based resins.

6. The process according to claim 1, wherein said step of impregnation of the resin within said mold is carried out substantially at ambient (room) temperature.

7. The process according to claim 5, wherein said resin is a furan based resin, said diluent is water, and said step of dilution of the resin provides that said resin is diluted with water in a range from 10% to 15% by weight with respect to the total weight of the final mixture water-resin.

8. The process according to claim 7, wherein said catalyst is an acid catalyst selected from the group of strong acids according to Bransted.

9. The process according to claim 8, wherein said catalyst is phosphoric acid or para-toluenesulfonic acid.

10. The process according to claim 1, wherein said step of impregnation of the reinforcement fibers or fabric through said resin within said mold takes place according to the following methods:
infusion of said pretreated resin within said mold; or manual impregnation with the pretreated resin.

11. A fibrous material or fibrous fabric capable of constituting a reinforcing material for composite material products that include resin, said resin being adapted to totally impregnate said fibrous material or fibrous fabric, characterized in that said fibrous material or fibrous fabric is pre-impregnated with only a catalyst compatible with said resin.

12. A composite material comprising a layered structure comprising at least one reinforcement layer of fibers or fibrous fabric, and at least one layer of resin which impregnates totally said at least one layer of fibers or fibrous fabric, characterized in that said reinforcement layer of fibers or fibrous fabric is a layer of pre-impregnated fibers with only a catalyst compatible with said resin.

13. A composite material according to claim 12, wherein the reinforcement fibers or fibrous fabric are pre-impregnated with only the catalyst in an amount between 1% and 50% by weight with respect to the areal weight of the fabric.

14. A composite material according to claim 12, wherein said resin is selected from the following group:
Epoxy; Polyesters; Vinylester; Phenolic; and Furan Based resins.

15. A product comprising the composite material according to claim 12, wherein said product is a manufactured article selected from:
a) a laminated structure which includes:
Pre-preg fibers or fibrous fabrics with only the catalyst; and resin;
b) a sandwiched panel which includes:
Pre-preg fibers or fibrous fabrics with only catalyst; a core of any material, shape and thickness; and resin.
